(19) United States
(12) Patent Application Publication
(10) Pub. No.: US 2026/0143177 A1
(43) Pub. Date: May 21, 2026

(54) ARTIFICIAL INTELLIGENCE-DRIVEN SYSTEM FOR VALIDATION OF LIVESTREAMED EVENT CONTENT FOR DISPUTE RESOLUTION

(71) Applicant: Ryval Technologies, Inc., Miami, FL (US)

(72) Inventors: Steve Shute Tsao, Manila (PH); Mimi St. Johns, Miami, FL (US)

(21) Appl. No.: 19/392,607

(22) Filed: Nov. 18, 2025

Related U.S. Application Data
(60) Provisional application No. 63/721,580, filed on Nov. 18, 2024.

(51) Int. Cl. H04N 21/2187; G06V 10/776; H04N 21/84

(52) U.S. Cl. CPC H04N 21/2187; G06V 10/776; H04N 21/84

(57) ABSTRACT

Computer-implemented methods and systems for validating outcomes in livestreamed video events are provided. The methods involve receiving a live video stream, generating a broadcast feed and a parallel analysis feed, selecting video frames at a cadence, and adding timestamps and checksums to the selected frames. An artificial intelligence (AI) vision model detects irregularities in the video frames, and an AI optical character recognition (OCR) or vision-LLM model determines an outcome state, such as victory, defeat, or mission completion. An outcome record is generated, including the outcome state, timestamp, confidence score, and references to video frames, and sent to a web server for display. The system includes modules for screen capture, video/audio recording, metadata collection, and AI analysis to detect irregularities and generate reports. The methods and systems are able to validate outcomes in livestreamed events and settle prediction markets.

### FIELD OF INVENTION

This disclosure relates to artificial intelligence-driven systems and livestreamed events.

### BACKGROUND

In various livestreamed competitive events, disputes arise concerning the legitimacy and outcomes of events such as esports matches, sports events, and online competitions. Manually analyzing and resolving these disputes is time-consuming, labor-intensive, and prone to human error or bias and delays results. Current solutions lack an automated system that can reliably analyze and verify the integrity of livestreamed content in real-time or post-event. Therefore, a need exists for an AI-driven process that systematically validates livestreamed event content to settle disputes and validate outcomes efficiently, accurately, and impartially.

### SUMMARY OF THE INVENTION

In one aspect, this disclosure provides a computer-implemented method for validating an outcome in a livestreamed video event. The method comprises receiving, at a platform, a live video stream of an event from a livestream source; generating, at the platform, a broadcast feed comprising the live video stream and a parallel analysis feed comprising video frames from the live video stream; selecting, at the platform, a plurality of video frames at a predetermined cadence; adding, at the platform, a timestamp and checksum to each selected video frame; applying, at the platform, an artificial intelligence vision model to the selected video frames to detect an outcome screen; when an outcome screen is detected, applying, at the platform, an artificial intelligence optical character recognition (OCR) or vision-LLM model to determine an outcome state selected from the group consisting of victory, defeat, score threshold met, mission completion, end-or-round state, achievement medal awarded, item acquisition or loss, environmental trigger detection, timer expiration, streamer activity state, performance, and stream state transition; generating, at the platform, an outcome record comprising the outcome state, an outcome timestamp, and a reference to one or more selected video frames; and sending, from the platform, the outcome record and instructions for displaying the outcome record to a web server.

In some embodiments, the method further comprises causing, by the platform, settlement, based at least in part on the outcome record, of a prediction market operably connected to the platform.

In some embodiments, the method also comprises sending, from the platform, the broadcast feed, with zero latency or near-zero latency, to a streaming platform.

In some embodiments, the instructions for displaying the outcome record comprise instructions for displaying the outcome record on a website, a chatbot, a mobile application, a streaming software plugin, a third-party integrated application, an email, an SMS, or a push notification.

Another aspect of this disclosure provides a system for validating a result in a livestreamed video event. The system comprises a screen capture module configured to capture livestream information from a livestream broadcast feed and generate captured livestream information, wherein the captured livestream information comprises video frames captured at a cadence; a video and audio recording module configured to extract video and audio content from the captured livestream information; a metadata collection module configured to capture metadata from the stored/captured livestream information, wherein the metadata comprises one or more of a timestamp, a player identification, a match identification, an event identification, UI overlay signatures, player action sequence, or motion cues; an artificial intelligence (AI) model configured to detect an outcome screen in video and audio content extracted by the video and audio recording module based on the AI model being trained on historical data, predefined templates, and expected behavior data; detect one or more of a timing irregularity, behavioral irregularity, unnatural behavior indicative of tampering, or a combination thereof in the extracted video and audio content; determine an outcome state; and generate an outcome report comprising a determination of the outcome of the livestreamed video event; and a dispute resolution interface configured to display the outcome report.

In some embodiments, the AI model is further configured to perform a timing analysis on the extracted video and audio content.

In some embodiments, the AI model is further configured to assign a confidence score to the outcome report.

Yet another aspect of this disclosure provides a computer-implemented method for training an artificial intelligence model to validate an outcome in a livestreamed video event comprising: receiving, at a platform, a live video stream of an event from a livestream source; generating, at the platform, an analysis feed comprising video frames from the live video stream; selecting, at the platform, a plurality of video frames at a cadence; generating, at the platform, a first set of outcome frames from the selected plurality of frames; training, at the platform, an artificial intelligence vision model using the set of outcome frames; generating, at the platform, a second set of outcome screens; applying, at the platform, the AI vision model to the second set of outcome screens to validate the AI vision model, generating, at the platform, a third set of outcome screens; applying, at the platform, the AI vision model to the third set of outcome screens to test the AI vision model, wherein the AI vision model is tested when the AI vision model correctly detects the third set of outcome screens.

### BRIEF DESCRIPTION OF FIGURES

FIG. 1 is a block diagram depicting an embodiment of the system.

FIG. 2 is a block diagram depicting an embodiment of the process described herein.

FIG. 3 is a block diagram depicting a training model and a prediction model.

### DETAILED DESCRIPTION

This disclosure relates to systems and methods for judging results, adjudicating disputes, detecting irregularities, determining outcomes, and validating outcomes in livestreamed video events. In particular, the systems and methods leverage artificial intelligence (AI) models for real-time analysis and validation of livestream event outcomes. The described technology pertains to the use of AI-driven vision and optical character recognition (OCR) or vision-LLM models to detect irregularities, determine outcome states, facilitate dispute resolution, and settle prediction markets in the context of livestreamed events, such as gaming competitions or other interactive digital experiences.

As used herein, the articles “a” and “an” mean one or more than one, unless context dictates otherwise.

The computer-implemented methods and systems of this disclosure act as an AI judge for livestream outcome validation. The system receives a clean feed of a creator's livestream via direct streaming credentials (i.e., the stream URL and the stream key). The system splits the livestream into two streams: generating one stream for zero-latency or near-zero latency broadcast delivery and a second analysis stream for concurrently sampling frames for server-side AI validation. The system sends the zero latency broadcast to a streaming platform such as Twitch, Kick, YouTube Live, Facebook Gaming, Trovo, DLive, or similar platforms.

The methods and systems detect outcome screens and state transitions and create outcome reports suitable for settling markets. The system captures frames in the analysis stream at a controlled cadence, for example, at about 2, about 3, about 4, about 5, about 6, about 7, about 8, about 9, about 10, about 11, or about 12 FPS. To the captured frames, the system applies a vision model and an optical character recognition model or vision-LLM model tuned to streaming user interface artifacts, including end-of-match banners, scoreboards, timers, timestamps, player identifiers, or match and event identifiers. The system aggregates model detections over short windows of time to generate structured verdicts or validations and triggers settlement for associated prediction markets. End-round cards, scoreboard patterns, and mission banners are mapped into standardized market labels (e.g., win/lose, margin buckets, kill buckets, total-rounds buckets). Structured verdicts include confidence measures and pointers to evidence supporting the verdict, including relevant screenshots. Each analyzed frame carries a timestamp and checksum. Decisive evidence frames are persisted with market identifiers. In some embodiments, digital signatures can be layered by signing the outcome record and frame hashes with a private key.

The systems of this disclosure comprise a screen capture module that captures livestream information from a broadcast feed and generates video frames at a defined cadence. A video and audio recording module extracts relevant audio and video content from the captured livestream data. A metadata collection module collects metadata identifiers associated with the livestream such as timestamps, player identification, match identification, and event identification. An AI OCR or vision-LLM model compares the extracted video and audio content to historical data, predefined templates, and expected behavior data, enabling the detection of timing irregularities, behavioral anomalies, and signs of tampering. The AI model assigns a confidence score to detected irregularities and generates an irregularity report summarizing the findings. A dispute resolution interface then displays a validation report comprising the irregularity report and an outcome result, providing stakeholders with a transparent and structured basis for adjudicating disputes in livestreamed video events.

In some embodiments, the AI model is further configured to perform a timing analysis on the extracted video and audio content. In embodiments applying a timing analysis, the AI model is trained to detect a frame that is out of sequence in a livestream. For example, if a streamer is about to lose a match, the streamer can insert a screenshot of a previous winning game before the current game ends. The streamer is able to do this because the streamer controls the stream. The AI model would be trained on frame sequence and be able to detect when a frame is inserted out of sequence. In some embodiments, the AI model is configured to detect whether a streamer or a streamer's linked friend has placed a wager in a prediction market and whether the streamer has intentionally lost a match. These two embodiments enhance the AI model's ability to detect fraud.

After the initial analysis of image, video, and audio data, the AI model produces structured text-based information, such as metadata, tags, and extracted text elements. Regular expressions (sometimes referred to as “regex”) are systematically applied to this output to identify and extract specific patterns, including dates, keywords, and spatial coordinates, ensuring that only the most relevant information is retained for further validation. This targeted extraction streamlines the process and supports the accuracy of downstream applications. Regular expressions also facilitate the validation and normalization of extracted data. For example, date formats and other text patterns may vary depending on the source or region, and regular expressions enable their conversion into a standardized format. This normalization step plays a significant role in maintaining a structured output that can be reliably interpreted by subsequent modules in the system. Regular expressions are also used to filter out extraneous or irrelevant data, such as random alphanumeric strings or incomplete fragments, thereby reducing noise and improving the overall quality of the processed information.

The system also provides a user interface where event organizers and stakeholders can review validation reports and flagged issues. This interface enables the settlement of disputes based on the evidence provided by the AI-driven analysis, ensuring that contested event outcomes are resolved transparently and reliably. By leveraging regular expressions and AI-driven validation, the system delivers structured, accurate, and actionable information that supports robust dispute resolution in livestreamed video events. In some embodiments, the user interface is displayed on a website, a chatbot, a mobile application, a streaming software plugin, via an API for third-party integration, automated notification systems (e.g., email, SMS, push), or a browser extension.

The generated models can be monitored to determine when they meet operational requirements and can be reliably used for analyzing the captured information and detecting anomalies. If the AI detects discrepancies or suspicious behavior, the system generates a detailed report outlining the specific issues. This report can be reviewed by human moderators or used as evidence in dispute resolution proceedings. Upon completion of the validation process, the system generates a comprehensive validation report that includes significant observations, detected anomalies, a summary of behavioral and timing analysis, and the AI's confidence score.

This disclosure provides an artificial intelligence (AI) model based on unsupervised and/or semi-supervised machine learning that automatically trains (e.g., generates, develops, builds, monitors, enhances, etc.) models that compare captured content against predefined templates for expected outcomes. The AI models are trained using one or more templates obtained from different video games. These templates may include specific visual cues (e.g., game-ending screens), expected screen layouts, or typical audio markers indicating the end of a match or event. The AI then incorporates historical data associated with the specific event host or participants. This data may include prior game data, average completion times, common event behaviors, and typical screen layouts or configurations. The AI model uses this data to compare the current livestreamed event to historical trends and detect differences. Using machine learning, the AI assesses participant and host behavior to identify irregularities that may suggest manipulation or unnatural behavior, including screen size, layout, and positioning based on known configurations, pauses, out-of-sync instances, or timing discrepancies that may suggest tampering or unfair play, unusually fast transitions, frequent screen size changes, or repeated pauses. Once the model meets operational minimum requirements through machine learning of templates, historical data integration, and behavioral data integration, the model can become operational.

Embodiments of this disclosure enable models to automatically determine from the frames captured from a livestream outcome results as compared to the templates and historical data the model was trained on. During training, captured frames can be analyzed for validation by manually checking the outcome results and the validation result can be cross checked with the AI trained model for the purpose of further verification and inspection. Once the model has been sufficiently trained and self-validates for operational use, the model can become the primary validator. Through machine learning, the model becomes more accurate over time.

Through machine learning, the AI model is also able to build assessments of individual streamers. The AI model learns over time the frequency with which individual streamers's livestreams contain detected irregularities. Over time, the AI model is able to compose a validation assessment score of an individual streamer based on irregularities detected over time in a plurality of the individual streamer's livestreams.

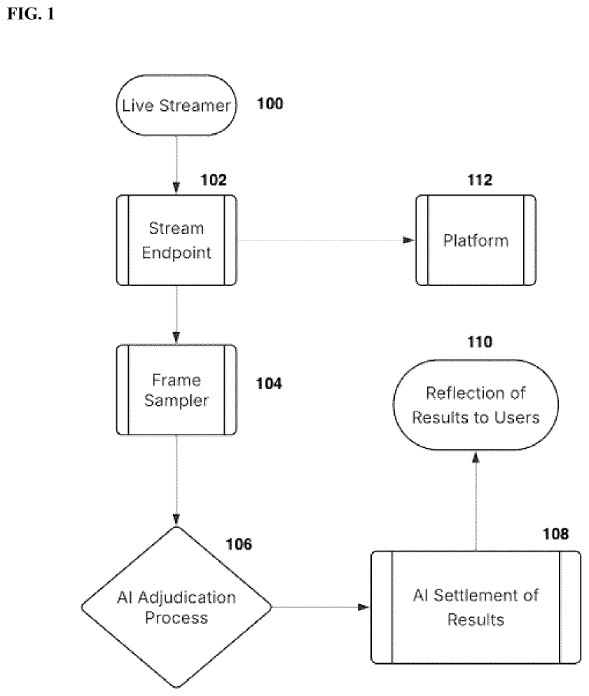

Referring now to FIG. 1, Live Streamer 100 sends data to Stream Endpoint 102 receives a live video stream event from Live Streamer 100. Stream Endpoint 102 generates a zero-latency broadcast feed and sends it to Platform 112. Stream Endpoint 102 also generates a captured livestream comprising video frames and sends the captured livestream to Frame Sampler 104. Frame Sampler 104 extracts video and audio contents from the captured livestream at a preset cadence. At AI Adjudication Process 106, an artificial intelligence vision model is applied to the extracted video and audio content to detect any irregularities. Also at AI Adjudication Process 106, an artificial intelligence OCR or vision-LLM model is applied to determine an outcome state. Once an outcome state is determined, the process proceeds to AI Settlement of Results 108, which an outcome record. AI Settlement of Results 108 sends the outcome records to Reflection of Results to Users 110, which is an interface for displaying the outcome record.

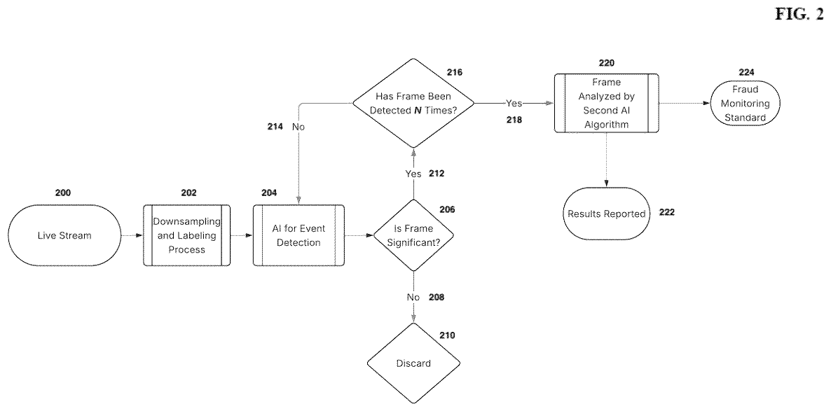

Referring now to FIG. 2, at Downsampling and Labeling Process step 202 a livestream video feed is received from Live Stream 200. At Downsampling and Labeling Process step 202, audio content and video frames are extracted from the captured livestream and metadata is extracted from the livestream. At AI for Event Detection 204, extracted audio content, video frames, and the metadata are received. AI for Event Detection 504 applies an AI vision model to a frame to determine whether the frame is significant at step 206, e.g., to detect whether a frame contains any irregularities or is an end screen. If the AI vision model determines that the frame is not significant at step 208, i.e., the frame does not contain any irregularities and does not correspond to an endpoint or template screen, the frame is discarded at step 210. If the AI vision model determines that the frame is significant at step 212, the AI vision model determines whether the frame has been detected a certain number of times N at step 216. If the frame has not been detected N times at step 214, the process reverts back to step 204. If the frame has been detected N times at 218, then the process proceeds to step 220 Frame Analyzed by Second AI Algorithm, i.e., the AI OCR or vision-LLM model is applied to determine an outcome. Once an outcome is determined, results are reported at step 222. Additionally, at step 224, the AI OCR or vision-LLM model is applied to detect fraud, e.g., detect unnatural behaviors described in this disclosure.

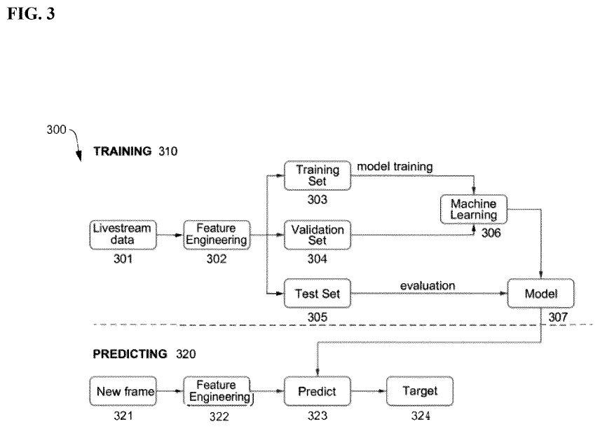

FIG. 3 illustrates a two-stage method 300 for an artificial intelligence learning model according to an exemplary embodiment. In some embodiments, there are two stages to the AI learning model: training 310 and predicting 320.

With respect to training stage 310, the AI model receives livestream data at 301. As explained, the received data includes captured frames including end result outcome screens. Next, the AI model, at feature engineering 302, generates a set of outcome screens for model training 303, validation 304, and/or testing 305. The generated set of outcome frames can be extracted from the images, extracted sub-images, text, and other features that are identifiable in the captured screens. Additional data may be used, including other extractable data available in a livestream.

Upon receiving data from a plurality of livestreams, data from a first subset of captured screens can be used to train the AI model, at 303 (e.g., certain outcome screens). Subsequently, a second subset of outcome screens can be used to validate the AI model at 304, i.e., to make sure the model is correctly recognizing certain outcome screens. Further, a third subset of outcome screens can be used to test the AI model at 305.

Machine learning 306 is used to generate the AI model for use against further livestreams. With the receipt of each livestream, and captured screens therefrom, the AI model is continuously trained. The machine learning or training can be done in an unsupervised mode where basic classification is done using some features (such as game over or time expiration) and model 307 is self-generated. Alternatively, in a semi-supervised mode for training the model, human input can perform cross-checks to inform model 307.

With respect to the predicting stage 320, generated AI model 307 is applied to a livestream, including frames captured from the livestream at a certain cadence. At the outset, a plurality of captured screens is received at 321. The received screen include audio and visual content captured from the livestream via the screen capture module as described. Next, the AI model, at feature engineering 322, can generate a set of features for model training, validation, and/or testing. The generated set of features can be extracted from the extracted audio and visual content, i.e., images, extracted sub-images, text, audio, and other features as described herein.

Next, at 323, the AI model is applied to the received captured frame to either validate the screen as an outcome result, identify one or more new features for incorporation into the AI model, determine that it is potentially a new screen, or detect an anomaly in the screen.

The AI model can be hosted as a server-based or cloud-based service for a system to validate the data of a livestream without having to support the training of the model on-premises. As used herein, the term “platform” can refer to the AI model and an interpreter being hosted on one or more servers or in the cloud.

The use of AI model validation enables the model to automatically and continuously update from new livestreams. To accurately detect outcomes, the AI model learns to recognize unnatural behavior. At 324, when a new captured screen is being analyzed for validation, the AI trained model determines if the screen contains unnatural behavior.

1. A computer-implemented method for validating an outcome in a livestreamed video event comprising:
receiving, at a platform, a live video stream of an event from a livestream source;
generating, at the platform, a broadcast feed comprising the live video stream and a parallel analysis feed comprising video frames from the live video stream;
selecting, at the platform, a plurality of video frames at a predetermined cadence;
adding, at the platform, a timestamp and checksum to each selected video frame;
applying, at the platform, an artificial intelligence vision model to the selected video frames to detect an outcome screen;
when an outcome screen is detected, applying, at the platform, an artificial intelligence optical character recognition (OCR) or vision-LLM model to determine an outcome state selected from the group consisting of victory, defeat, score threshold met, mission completion, end-or-round state, achievement medal awarded, item acquisition or loss, environmental trigger detection, timer expiration, streamer activity state, performance, and stream state transition;
generating, at the platform, an outcome record comprising the outcome state, an outcome timestamp, and a reference to one or more selected video frames; and
sending, from the platform, the outcome record and instructions for displaying the outcome record to a web server.

2. The method of claim 1, further comprising causing, by the platform, settlement, based at least in part on the outcome record, of a prediction market operably connected to the platform.

3. The method of claim 1, further comprising sending, from the platform, the broadcast feed, with zero latency or near-zero latency, to a streaming platform.

4. The method of claim 1, wherein the instructions for displaying the outcome record comprise instructions for displaying the outcome record on a website, a chatbot, a mobile application, a streaming software plugin, a third-party integrated application, an email, an SMS, or a push notification.

5. A system for validating a result in a livestreamed video event comprising:
a screen capture module configured to capture livestream information from a livestream broadcast feed and generate captured livestream information, wherein the captured livestream information comprises video frames captured at a cadence;
a video and audio recording module configured to extract video and audio content from the captured livestream information;
a metadata collection module configured to capture metadata from the stored/captured livestream information, wherein the metadata comprises one or more of a timestamp, a player identification, a match identification, an event identification, UI overlay signatures, player action sequence, or motion cues;
an artificial intelligence (AI) model configured to
detect an outcome screen in video and audio content extracted by the video and audio recording module based on the AI model being trained on historical data, predefined templates, and expected behavior data;
detect one or more of a timing irregularity, behavioral irregularity, unnatural behavior indicative of tampering, or a combination thereof in the extracted video and audio content;
determine an outcome state; and
generate an outcome report comprising a determination of the outcome of the livestreamed video event; and
a dispute resolution interface configured to display the outcome report.

6. The system of claim 4, wherein the AI model is further configured to perform a timing analysis on the extracted video and audio content.

7. The system of claim 5, wherein the AI model is further configured to assign a confidence score to the outcome report.

8. A computer-implemented method for training an artificial intelligence model to validate an outcome in a livestreamed video event comprising:
receiving, at a platform, a live video stream of an event from a livestream source;
generating, at the platform, an analysis feed comprising video frames from the live video stream;
selecting, at the platform, a plurality of video frames at a cadence;
generating, at the platform, a first set of outcome frames from the selected plurality of frames;
training, at the platform, an artificial intelligence vision model using the set of outcome frames;
generating, at the platform, a second set of outcome screens;
applying, at the platform, the AI vision model to the second set of outcome screens to validate the AI vision model,
generating, at the platform, a third set of outcome screens;
applying, at the platform, the AI vision model to the third set of outcome screens to test the AI vision model, wherein the AI vision model is tested when the AI vision model correctly detects the third set of outcome screens.
